(19) United States
(12) Patent Application Publication
(10) Pub. No.: US 2015/0361671 A1
(43) Pub. Date: Dec. 17, 2015

(54) Interchangeable Bracket Flange System

(71) Applicant: Jad Honein, Seattle, WA (US)

(72) Inventor: Jad Honein, Seattle, WA (US)

(21) Appl. No.: 14/751,505

(22) Filed: Jun. 26, 2015

(51) Int. Cl. E04F 11/18; F16M 13/02

(52) U.S. Cl. CPC E04F 11/1804; F16M 13/02

(57) ABSTRACT

The interchangeable bracket flange system is designed to connect any type of bracket to any type of material (wood, concrete, glass, steel, sheet rock etc.) using the wall, glass or steel adaptor flange. The design has a smooth look, no screw is exposed to the user.

The invention of the Interchangeable Bracket Flange System (IBFS) was driven by a need of a modular and easy-to-use single bracket system that is able to connect a Handrail Bracket to a wall, a post, or to glass. Currently, product manufacturers have to create one bracket for each different installation medium. The IBFS is an all-in-one bracket that is used seamlessly as a wall, post or glass bracket and works with a variety of materials such as sheet rock, wood, steel, etc. Furthermore, due to the unique mounting specifications, the IBFS fastens to any medium without mounting screws or a base cover creating a more sleek and modern looking design without sacrificing strength.

The IBFS is made of three flange components: the Wall Flange (WF), used to connect to a wall, the Steel Adaptor Flange (SAF), used to connect to a steel post and the Glass Adaptor Flange (GAF), used to connect to glass (FIGS. 1-4). The IBFS connects to the bracket by inserting what is called a Flange Column into the bracket column and securing it with a Small Pointed Head Screw (FIG. 8). The Flange Column is a standup column, has a v-shaped tip (FIG. 7) that is designed to catch Small Pointed Head Screw for strength and sturdiness when installing (FIG. 8). The head of the Flange Column can be Hex head, Socket head, or Philip head, Star shaped head, etc.

### BRIEF DESCRIPTION OF THE SEVERAL VIEWS OF THE DRAWINGS

FIG. 1 shows a Wall Flange (WF).

FIG. 2 shows a Steel Adaptor Flange (SAF).

FIG. 3 shows a Glass Adaptor Flange (GAF).

FIG. 4 shows an example of a bracket that is compatible with the 3 flanges.

FIG. 5 shows a WF with a particular type of head.

FIG. 6 shows a SAF with the Flange Column.

FIG. 7 shows a GAF with the V-shape Channel.

FIG. 8 shows a Bracket installed on the wall using a WF with the Pointed Screw.

FIG. 9 shows a flange.

FIG. 10 shows a flange.

FIG. 11 shows a flange.

FIG. 12 shows a top view of the GAF

FIG. 13 shows a cut view of the GAF

FIG. 14 shows an isometric view of the GAF

FIG. 15 shows a complete installed glass bracket.

FIG. 16 shows a complete bracket on glass.

FIG. 17 shows a top view of a SAF

FIG. 18 shows a side view of a SAF with screw welded on

FIG. 19 shows a top view of a Dome Round Adaptor

FIG. 20 shows a side view of a Dome Round Adaptor

FIG. 21 shows a side view of another type of SAF, the screw comes separately in this case

FIG. 22 shows an isometric view of a SAF

FIG. 23 shows a SAF installed on a tube with threaded hole.

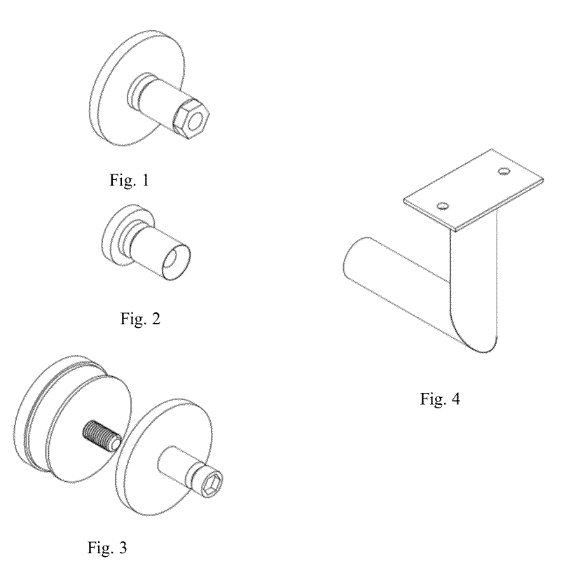

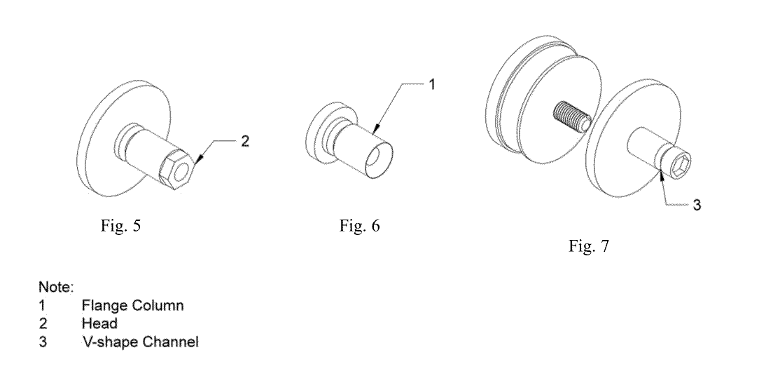

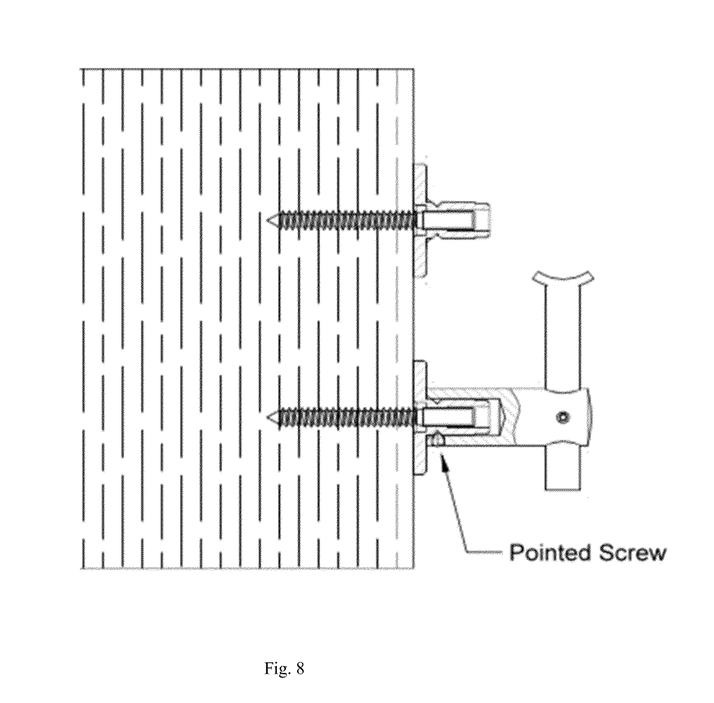

### DETAILED DESCRIPTION

### 1) Installing to a Wall (Wood Stud, or Sheet Rock With Wood, or Steel Stud Behind It)

The Wall Flange (WF) is a thin piece of metal that connects to the Flange Column. It can be circular or rectangular shape depends on the style of the bracket.

The Handrail Bracket should be able to withstand a minimum of 200 pounds of force down by code. Connecting surfaces such as wood or sheet rock can be easily deformable with this amount of pressure over time. The Wall Flange is designed to be larger than the bracket so it is able to distribute the forces coming from the handrail over a larger contact area and prevent deterioration or deformation.

An Anchor Screw is included to connect the Wall Flange to the wood stud. It is a special screw that has machine thread from the Wall Flange side and lag thread from the wood side. The Anchor Screw is like an adapter screw between the steel of the Wall Flange and the wood or steel stud from the wall side. FIG. 8 shows a complete bracket installed on the wall.

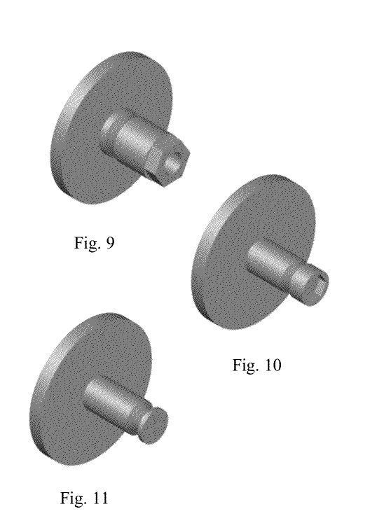

FIGS. 9-11 show different type, and size of flange. They both have the V-shape channel to connect to the bracket, with different type of head (i.e., hex head, Phillips head, Allen wrench head, star head, etc. . . . )

### 2) Connecting to Glass

The Glass Adaptor Flange (GAF) has the same flange area as the Wall Flange in order to prevent damage around the area to which the bracket is attached and thus can withstand pressure coming from the rails. The minimum recommended glass thickness is ½″ tempered or laminated glass.

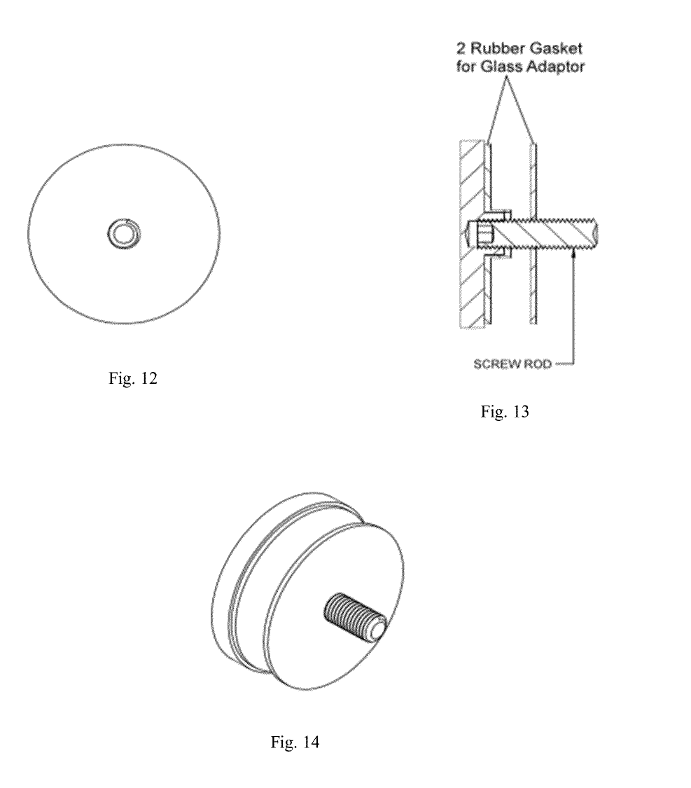

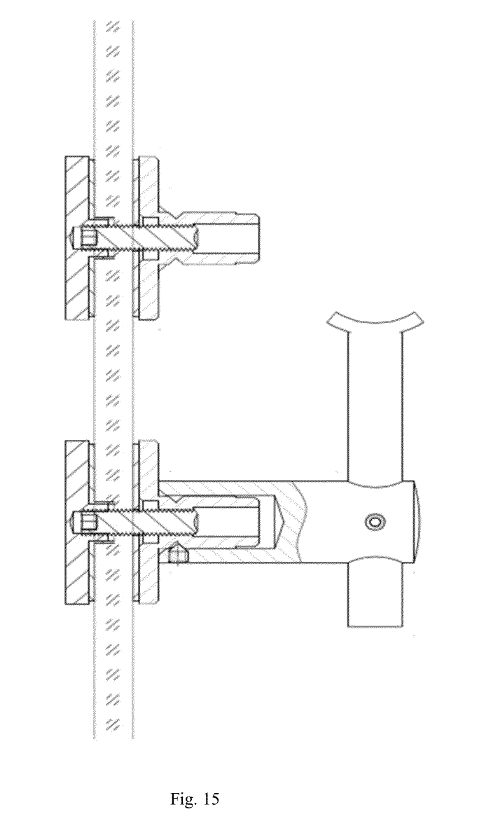

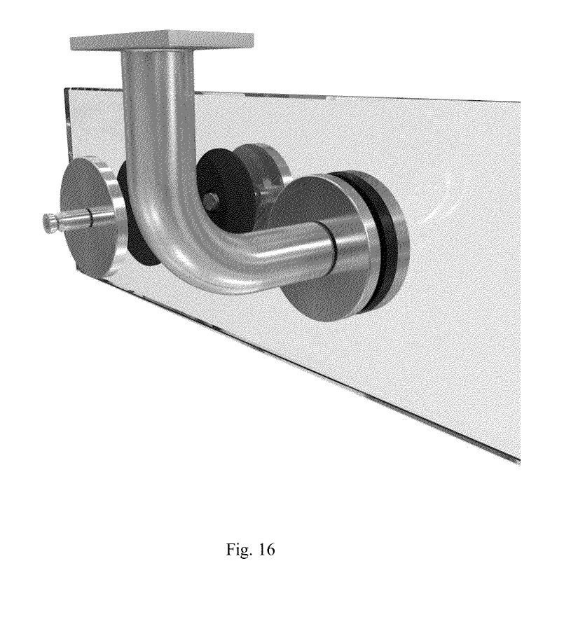

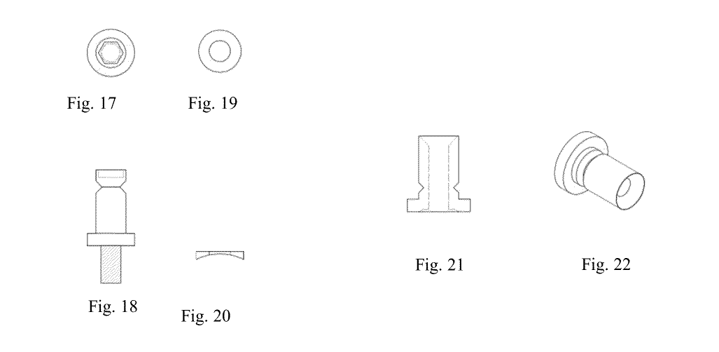

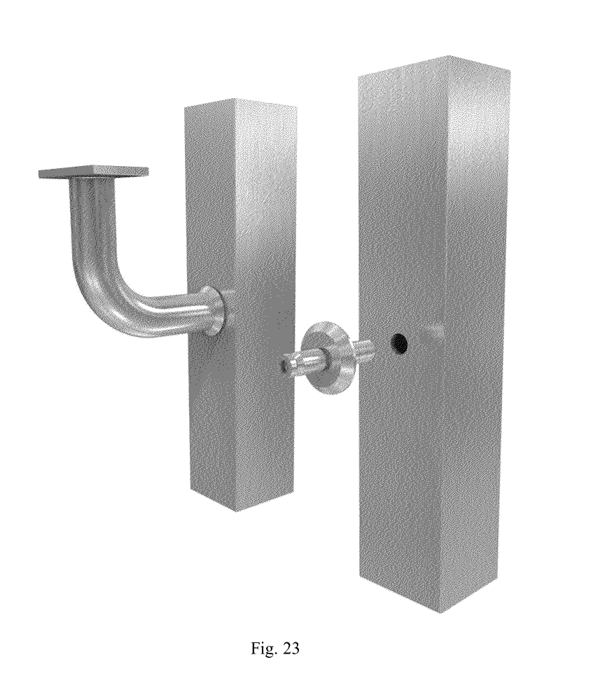

To install the Glass Adaptor Flange the user mounts a Screw Rod, a threaded rod that projects out of the flange, into the Wall Flange. Then, Wall Flange and Screw Rod is inserted through the glass and then screwed into the GAF from the other side of the glass (FIGS. 12-14). A rubber is inserted in between the Wall Flange and the glass and again an another rubber is inserted in between the glass and the GAF from the other side in order to further protect the glass. The finished result is a seamless handrail completely supported by a glass surface (FIG. 11).

### 3) Connecting to Steel

The Steel Adaptor Flange (SAF) is a thin piece of metal with a smaller diameter than the Wall Flange. The Wall Flange is not needed in this instance due to the strength of the steel the bracket will be attached to. Also, most posts are more narrow than the Wall Flange and would not make esthetic sense.

Installation of the SAF requires a connection screw (like the GF) that is either welded onto the SAF or included separately, depending on the installation method of the user. The screw part of the Steel Adaptor Flange is used to connect the bracket to a steel surface that has a threaded hole. The SAF also includes a Dome Round Adaptor for securing to a round steel post. The Dome Round Adaptor has a recessed part to accommodate the encapsulation of the flange of a rivet nut if used.

The threaded hole into the steel is achieved by inserting a rivet nut or the post itself can have threads embedded into it by a flow drilling process or some other process that creates the threads that are part of the steel. The SAF is designed with a recessed area that is intended to englobe the flange of a rivet nut of the connecting steel surface when a rivet nut is used.

After mounting the SAF to the side of a steel post, the user can slide the Bracket in now, and tightens the Small Pointed Head Screw.

1. The Interchangeable Bracket Flange System includes a wall flange to connect the bracket to the wall, the glass adaptor flange to connect to the glass, and the steel adaptor to connect to the post.

2. The IBFS has a round, square, or rectangular shape, and is used to connect a round or square wall bracket to a wall, a glass surface, or steel. The screw is hidden in the back of the flange making it so that there is no screw visible so that a cover is not needed to hide any unsightly hardware.

3. The interchangeable bracket flange system has a connection part-called a “flange column” which can have different type of head (i.e. Hex head, Socket head, or Phillip head), and is connected to the wall bracket using a pointed head screw, or glue. With the round shape, the user can rotate the bracket to the correct angle before securing it into position using either the pointed head screw, epoxy, or weld.
